(19) United States
(12) Patent Application Publication
(10) Pub. No.: US 2016/0059453 A1
(43) Pub. Date: Mar. 3, 2016

(54) Method and molding tool for the infusion of a matrix material

(71) Applicant: Deutsches Zentrum fuer Luft- und Raumfahrt e.V., Koeln (DE)

(72) Inventors: Matthias BOCK, Braunschweig (DE); Dirk ROESTERMUNDT, Peine (DE); Markus KLEINEBERG, Hemmingen (DE)

(21) Appl. No.: 14/833,217

(22) Filed: Aug. 24, 2015

(30) Foreign Application Priority Data
Aug. 27, 2014 (DE) 10 2014 112 311.5

(51) Int. Cl. B29C 45/14

(52) U.S. Cl. CPC B29C 45/14631; B29L 2022/00

(57) ABSTRACT

A method and a device for the infusion of a matrix material into a fibrous material is used for the production of a fiber composite component. The matrix material is infused into the fibrous material, which has been laid on the molding tool, by virtue of the matrix material from the reservoir being introduced from the infusion openings provided in the tool surface, such that said matrix material can be forced from said infusion openings into the fibrous material.

### FIELD OF THE INVENTION

The invention relates to a method and to an associated molding tool for the infusion of a matrix material into a fibrous material for the production of a fiber composite component.

### BACKGROUND

In the production of fiber composite components, it is generally the case that a matrix material that has been infused into a fibrous material is cured by the action of temperature on the component, such that the fibrous material embedded into the matrix material forms an integral component together with said fibrous material. This thus yields extremely high demands on strength and rigidity in particular in the fiber direction, whereas the component itself has a very low weight in relation to conventional materials.

In the production of fiber composite components in the so-called injection or infusion process, dry fibrous material is laid on a molding tool which has a shape-imparting tool surface which generally at least partially exhibits the subsequent component shape. With the aid of a pressure difference, for example by exertion of load on the matrix material by way of a positive pressure or the generation of a vacuum in the region of the fibrous materials (vacuum injection process), the matrix material is then infused into the dry fibrous material that has been introduced into the molding tool. After the fibrous material has been fully impregnated, the matrix material can be cured, and the fiber composite component thus produced, by virtue of the fibrous material being subjected to the action of temperature and, if appropriate, pressure.

An important process or quality parameter in this case is the complete impregnation of the dry fibrous material with matrix material. This is because regions that have not been fully impregnated with matrix material constitute a defect in the subsequently produced fiber composite component, which defect reduces the component quality and can impair the strength and rigidity of the component. Specifically in the case of fiber composite components in safety critical applications, such as for example in the case of rotor blades or pressure tanks, this rapidly leads to a rejection of the entire component, which increases manufacturing costs and thus ultimately the unit prices.

In particular, thick-walled structures in the field of the banding of fast-rotating rotors demand high tangential prestresses of the fibrous material in order to make it possible for targeted radial stress gradients to be introduced into the band. As a result, the laying of already pre-impregnated fibrous materials is difficult or even impossible, such that predominantly dry fibrous material is laid, which must be infused with a suitable matrix material at a later point in time.

Thread stresses of up to 100 MPa are used both for the wet winding process and for the dry winding process. This leads to fiber volume contents of up to 70 vol %. In this case, during the curing process, in particular in the case of so-called hoop windings, micro-bulging (outward buckling of the fibrous material during resin shrinkage) occurs at almost regular intervals in the circumferential direction per thread width, which in particular in the case of centrifugal loading, and in the presence of high internal pressure in the case of pressure vessels, leads to delamination, which in the case of rotors, reduces the load capacity and service life. Furthermore, in the case of lower fiber contents, in particular in the case of wet-wound structures, the hoop windings are afflicted with a loss of pre-stress of up to 30%. This can, in particular in the case of thick-walled structures, lead to fiber misalignment and fiber undulation which, in particular in the case of rotors, lead to undesired dynamic imbalances, which are difficult to tolerate.

In the case of thick-walled structures and/or pressure vessels produced in the dry-winding process, the resin infusion is performed by means of vacuum infusion methods, with and without autoclave assistance, from the outside inward. In the absence of pressure-stable outer tools, the maximum pressures with which the resin system can be charged are limited to atmospheric pressure and the autoclave pressure (autoclaves with 15 bar total pressure are known). In the case of higher fiber volume contents, it is not always possible, in particular in the case of thick-walled rotors and in the cylindrical regions of pressure vessels, for the fibrous material to be fully immersed regardless of the casting concept. Complete impregnation however always leads to reject parts, such that, in particular for series-produced pressure vessels, an enormous cost disadvantage is associated with this.

Rotors and pressure vessels composed of fiber composite materials are always composed to a major extent, or exclusively, of so-called hoop windings, which ideally have one fiber beginning and precisely one associated fiber end. Therefore, resin infusion via open fiber cross sections is not possible, as the path distance in a capillary normally amounts to more than one kilometer. Owing to the high packing density of the fibers, even autoclave-assisted infusion is normally not possible, as the flow resistance is too high owing to the filaments which are blocked on all sides, and is additionally increased by the application of external pressure. This applies in particular to thick-walled structures.

DE 198 59 798 C2 has disclosed a method and a device for producing molded bodies composed of fiber composite materials, in which method the fibrous material is laid on a molding tool and is closed off by way of a pressure bell housing, wherein, proceeding from the pressure bell housing, matrix material is then infused into the fibrous material.

EP 2 653 296 A1 has disclosed a vacuum infusion process for producing a wind turbine component, in which method the matrix material is infused into the fibrous material through an opening in the shape-imparting tool surface.

DE 10 2012 023 608 A1 has disclosed a method and a device for producing a molded part, in which method fibrous material is laid into a multi-part tool mold, wherein at least one side of the multi-part tool mold is flexible in order to allow the infused matrix material to be distributed more effectively.

DE 10 2007 027 755 A1 has disclosed a method for producing a fiber-reinforced plastics component, in which the fibrous material is wound on to a hollow core and subsequently laid into a multi-part tool mold. The matrix material is then infused into the fibrous material from the outside.

DE 101 40 166 A1 has disclosed a method and a device for producing fiber-reinforced components by means of an injection process, in which method the fibrous material is laid into a tool and is closed off in air-resistant fashion by means of a vacuum foil, wherein the matrix material is then infused into the fibrous material from the outside.

Finally, DE 10 2011 082 842 A1 has disclosed a method for producing structural components, in which method fibrous material is laid into a multi-part tool mold and is subsequently infused with matrix material from the outside.

### SUMMARY

Against this background, it is an object of the present invention to specify an improved method for the infusion of matrix material into a fibrous material, in particular in the case of rotor bands and pressure vessels, with which method a complete infusion of the matrix material and impregnation of the fibrous material can be ensured. It is also an object of the present invention to specify an improved device for this purpose.

Accordingly, there is proposed a method for the infusion of a matrix material into a fibrous material for the production of a fiber composite component, wherein according to the invention, in a first step, a molding tool is provided which has a tool surface in which there are provided infusion openings. Said infusion openings are connected in pressure-resistant fashion to a matrix material reservoir, such that matrix material from the matrix material reservoir can be forced out of the infusion openings provided in the tool surface.

In the next step, the fibrous material is then laid on the tool surface of the molding tool, specifically in particular in such a way that, after the process of laying the fibrous material has been completed, at least some, preferably all of the infusion openings in the tool surface are covered by the fibrous material, that is to say the fibrous material is laid over the infusion openings. The laying of the fibrous material may in this case be performed in automated fashion by way of a fiber-laying device, or may be performed manually.

After the laying of the fibrous material on the tool surface has been completed, such that at least some of the infusion openings in the tool surface are covered by the laid fibrous material, the actual infusion process for producing the fiber composite component is performed. For this purpose, by means of a pump or pressure device, the matrix material situated in the matrix material reservoir is conducted through the pressure-resistant connection to the infusion openings and forced out of these, such that the matrix material infuses into the fibrous material, which has been laid over the infusion openings, from the direction of the molding tool.

For this purpose, the molding tool may for example be introduced into an autoclave, wherein the fibrous material is forced against the molding tool by a pressure set in the autoclave. With a corresponding infusion pressure, it is then possible for the matrix material from the matrix material reservoir to be forced out of the infusion openings of the tool surface in order to infuse into the fibrous material, wherein, owing to the autoclave pressure, the fibrous material is pressed against the tool surface despite the infusion pressure.

It is advantageously provided that, before the laying of the fibrous material onto the tool surface of the molding tool, a flow promoter is laid over the infusion openings, onto which flow promoter the fibrous material is then laid. It can be ensured in this way that the matrix material forced out of the infusion openings of the tool surface is spatially distributed in an effective manner between the fibrous material and the tool surface, in order that said matrix material infuses into the laid fibrous material over the full area and in a complete manner.

After the matrix material has been forced through the injection openings and the laid fibrous material has been fully impregnated with the matrix material, the curing process can be commenced, for example by exposure to the action of temperature. In the process, the matrix material that has infused into the fibrous material is cured, such that the matrix material and fibrous material form an integral unit and thus the fiber composite component, with its advantageous characteristics, is produced.

In a further advantageous embodiment, it is conceivable for a molding tool to be provided which, in the tool surface, adjacent to the infusion openings, has a flow channel texture such that a multiplicity of flow channels are formed, for example by virtue of a grid structure being ground or milled. In this way, the matrix material can be distributed in a very effective manner under the fibrous material, and thus the probability of complete impregnation of the fibrous material is increased.

With the aid of the present invention, it is thus made possible for a fibrous material that has been laid on a tool to be fully infused with matrix material, even if, owing to the laying process or production process used, the fibrous material has been laid onto the tool with a high pressure or the fibrous material has a very high fiber volume content, which basically impedes an infiltration of matrix systems.

In a particularly advantageous embodiment, the infusion pressure with which the matrix material is forced out of the infusion openings is set such that the infusion pressure is greater than the contact pressure with which the fibrous material lies on the tool surface. Such a contact pressure may be set for example by virtue of the fibrous material being forced against the tool surface owing to an autoclave pressure. Such a contact pressure may also be set by virtue of the fibrous material having been laid under stress by winding technology, such that, owing to the set tangential thread stress, the fibrous material lies on the tool surface with a corresponding contact pressure over the full area.

In the case of an infusion pressure which is greater than the contact pressure, it is then the case that the matrix material is forced out of the infusion openings, wherein the matrix material that has been forced out expands the fiber layers of the fibrous material, and in particular the capillaries between the filaments, and is thus distributed areally between the fibrous material and the molding tool. In this case, the fibrous material is infused by the matrix material in gradual fashion radially from the inside to the outside counter to a generally uniform flow resistance. The effect of the distribution of the matrix material can in this case be improved by way of a corresponding flow channel structure, for example in the form of a flow promoter or milled flow channels.

According to the invention, a molding tool is provided which has a tool surface which is of encircling form in at least one direction and in which the infusion openings are provided radially around the circumference of the molding tool, wherein the infusion openings are connected to the matrix material reservoir via pressure-resistant connecting elements situated at the inside. Such an encircling tool surface may for example be a so-called liner, with which hollow components, such as for example rotor blades or pressure tanks, are produced from a fiber composite material. Said so-called liners, which have an encircling tool surface in at least one direction, then have fibrous material wound around them, for example by virtue of the molding tool being rotated about a corresponding axis and the encircling tool surface thus performing a circular movement. The fibrous material is then likewise laid in encircling fashion, in particular in continuously encircling fashion. In this case, it is advantageous in particular if the matrix material is then forced out of the infusion openings with an infusion pressure higher than the pressure with which the fibrous material lies on the tool surface. The forcing-out of the matrix material leads in this case to an expansion of the fibrous materials that have been laid in encircling fashion, resulting in an infusion of the matrix material into the fibrous material that has been laid in continuously encircling fashion.

Here, it is advantageous if a molding tool is provided in which, on the lateral boundary of the encircling tool surface, there are provided so-called winding shoulders in order thereby, with rigid dimensioning in accordance with the transverse forces to be expected from the winding process, to position the lateral pressure-resistant outer side, such that even for rotor bands, the all-round outer pressure-resistant tool side together with the fibrous material is realized.

In a further advantageous embodiment, a molding tool is provided which has an elastic tool surface in which the infusion openings are provided, wherein the elastic tool surface adjoins an internal cavity which can be charged with an internal positive pressure. Before, during or after the laying of the fibrous material onto the elastic tool surface, the cavity is charged with an internal positive pressure, wherein the matrix material from the matrix material reservoir is forced out of the infusion openings, provided in the elastic tool surface, with an infusion pressure which is greater than the internal positive pressure with which the cavity of the molding tool is charged.

It is thus conceivable that, before the laying of the fibrous material, a slight internal positive pressure is provided in order to adequately stabilize the molding tool with the elastic tool surface for the fiber laying process.

Owing to the fact that the infusion pressure is greater than the internal positive pressure of the cavity of the molding tool, it is the case that, as the matrix material is forced out of the infusion openings, the elastic tool surface yields to the infusion pressure, such that a gap forms between the fibrous material and elastic tool surface, in which the matrix material can propagate in order to infuse into the fibrous material.

Here, it is particularly advantageous if, after the laying of the fibrous material, the cavity is charged with an internal positive pressure such that the contact pressure with which the fibrous material lies on the tool surface is increased. In this way, it is possible to realize an increase in the fiber volume content, wherein at the same time, irregularities in the fiber laying process can be eliminated. Here, the cavity can be charged with an internal positive pressure up to the design load of the fibrous materials, wherein complete infusion of the matrix material into the fibrous material can nevertheless be attained owing to the once again increased infusion pressure.

For this purpose, it is particular advantageous if, after a predefined amount of matrix material has been forced out of the infusion openings, the pressure difference between the infusion pressure and the internal pressure is eliminated in order that the matrix material that has been forced out can infuse into the fibrous material, wherein, after a predefined time period has elapsed, the pressure difference between the infusion pressure and internal pressure is increased again, until the infusion pressure is again greater than the internal pressure. The setting of a pressure difference may be realized for example by virtue of the infusion pressure being increased or the internal pressure of the cavity being lowered. To eliminate the pressure difference, the infusion pressure may be lowered to substantially the internal pressure of the cavity, or the internal pressure of the cavity may be increased to substantially the infusion pressure.

Such a stepped infusion is necessary for example in the case of excessively low flow speeds in order to prevent vessel instability in the event of excessive deformations of the molding tool.

A further advantage of the elastic tool surface consists in that, by virtue of the molding tool being evacuated after the matrix material has cured, the molding tool can, with an adequately dimensioned pole opening, be removed from the vessel. For example, it is conceivable for a molding tool to be provided which has an elastic tool surface composed of a PE material, whereby the possible use of an elastic winding or mold core for the production of fiber composite structures is made possible. The mold core may in this case have a diameter of approximately 1 meter and a length of approximately 3 m, and may for example be composed of a PE material which has a thickness of 4 mm to 5 mm and which can be produced for example in a simple rotary casting process. For adequate stabilization of a molding tool of said type, the mold or winding core is charged with an internal positive pressure of approximately 100 mbar, which is adequate for corresponding fiber laying.

With the use of PE material, it is furthermore possible, for the demolding of a winding or mold core, for the molding tool to be melted and for the melt to be discharged. A prerequisite for this is the use of a resin system which is cross-linked at low temperatures and which reaches its final strength at temperatures far above the melting temperature of the material used for the molding tool, such that melting of the molding tool is made possible.

An elastic tool surface as a molding tool furthermore serves as an ideal shape-imparting element in the production process. By contrast to fixed, dimensionally stable winding tools, it is possible, with elastic tool surfaces, for contour imperfections and other geometric imperfections of the tool surface to be corrected after the fiber laying process has been completed. This is realized by simple pressurization of the produced components with pressures of up to the design load of the fibrous material. Here, deformations of the molding tool are generated which arise as a result of the displacement of imprecisely geodetically laid fibrous material and a non-isotensoidal outer contour of the molding tool in the so-called base regions of the vessel. The deformed vessel structure produced in this way constitutes approximately the optimum with regard to the maximum load capacity of the fiber composite structures.

In a further advantageous embodiment, the matrix material is forced out of the infusion openings by means of a hydraulically generated infusion pressure, whereby significantly higher infusion pressures can be set than in the case of conventional methods.

Furthermore, the invention is also achieved by means of a device for producing a fiber composite component from a fibrous material infused with a matrix material, wherein the device has a molding tool with a tool surface in which there are provided one or more infusion openings which are connected in pressure-resistant fashion to a matrix material reservoir. Furthermore, the device has a pressurization means which is designed to force the matrix material from the matrix material reservoir out of the infusion openings, in the direction of laid fibrous materials, with a predefined infusion pressure.

### DESCRIPTION OF THE FIGURES

The invention will be discussed by way of example on the basis of the figures, in which:

FIG. 1 shows a schematically illustrated side view of a winding tool;

FIG. 2 shows a sectional illustration of the schematically illustrated winding tool as per FIG. 1;

FIG. 3 shows a schematic illustration of a liner for producing pressure vessels.

### DETAILED DESCRIPTION

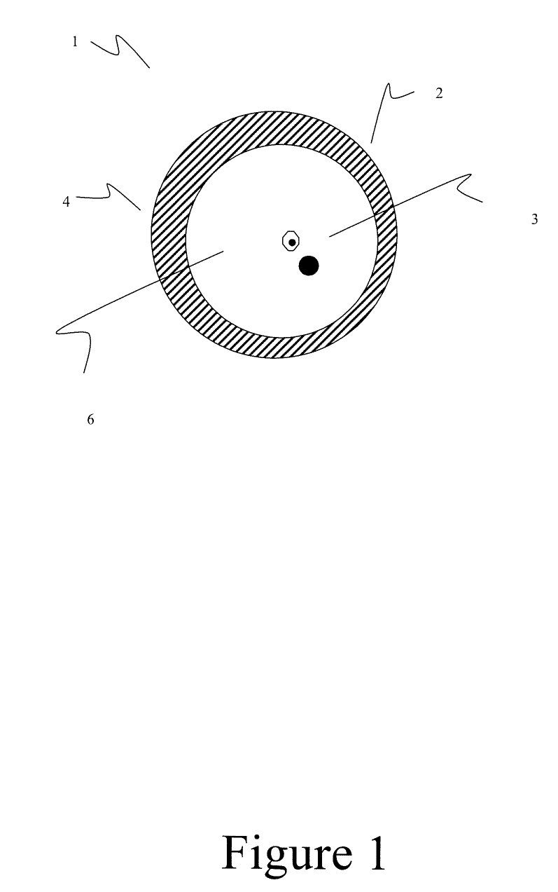

FIG. 1 schematically shows, in a side view, a molding tool 1 which, as a winding tool, has a tool surface 2 which is of encircling form in at least one direction. The molding tool 1 may in this case rotate about an axis 3 or shaft, such that the surface 2 performs a rotational movement. In this way, it is then possible for fibrous material to be laid in encircling fashion on the surface 2 of the tool. For the lateral support, so-called winding shoulders 4 are provided which serve for lateral delimitation of the fibrous material to be laid on the surface 2.

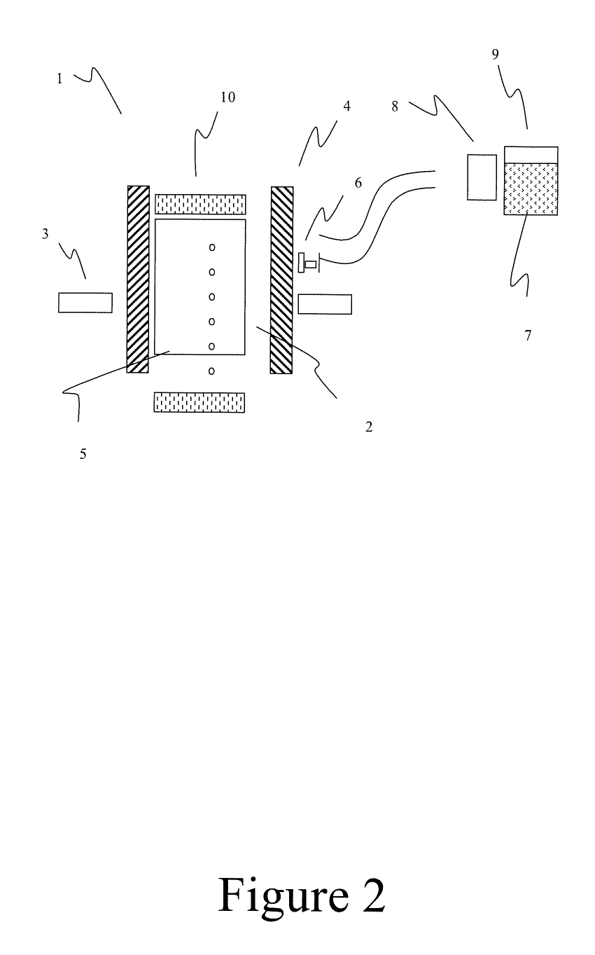

FIG. 2 schematically shows the winding tool 1 of FIG. 1 from a viewing angle rotated through 90°, specifically in a plan view of the tool surface 2. According to the invention, there is provided in the tool surface 2 a multiplicity of infusion openings 5 which are all connected via a pressure-resistant connection 6 to a matrix material reservoir 7.

By way of a pressurization means 8, the matrix material 9 contained in the matrix material reservoir 7 can, via the pressure-resistant connection 6, be forced out of the infusion openings 5 of the tool surface 2, such that a fibrous material 10 laid on the tool surface 2 can be infused with the matrix material 9 radially from the inside to the outside. FIG. 2 shows the fibrous material 10 laid on the tool surface 2 in a sectional illustration, in order thereby to afford a view of the tool surface 2.

The infusion pressure with which the matrix material 9, for example a resin system, is forced out of the infusion openings 5 should preferably be greater than the contact pressure of the fibrous material 10.

It is preferably possible, before the laying of the fibrous material 10 on the tool surface 2, for a coarse nonwoven to be underlaid as a flow promoter, in order that the matrix material forced out of the infusion openings 5 can thereby be areally well-distributed between the fibrous material 10 and the tool surface 2, in order to reliably achieve complete impregnation of the fibrous material 10. It is also conceivable for corresponding flow channels (not illustrated) to be milled into the tool surface 2, through which flow channels the matrix material is initially distributed over the tool surface 2 before subsequently then infusing into the fibrous material owing to the injection pressure.

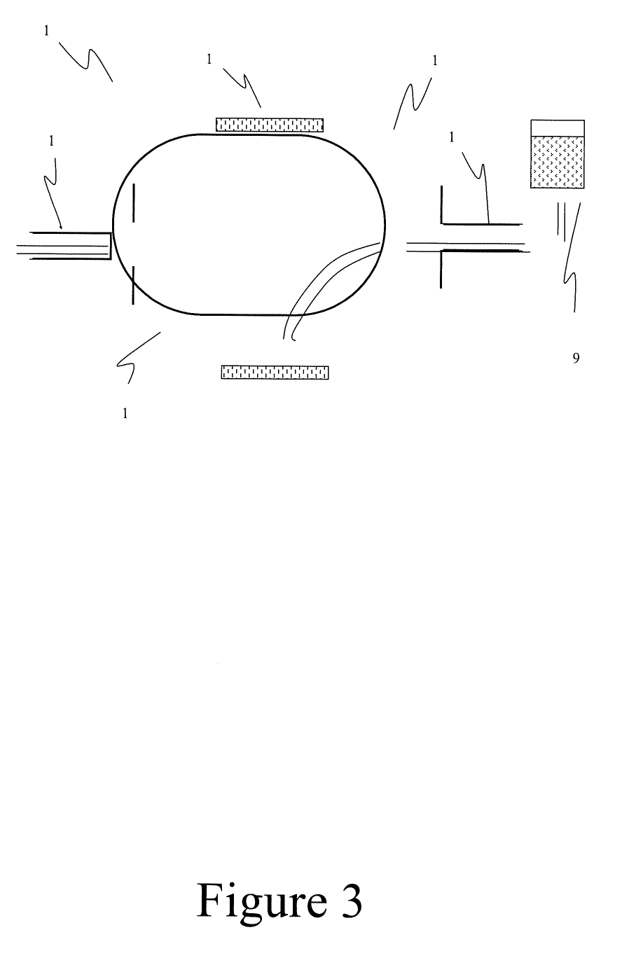

FIG. 3 schematically shows a liner 15 for the production of a pressure vessel from a fiber composite material. The liner 15 has, on one side, a pole opening 11 through which the sprue lines for the infiltration of the matrix material into the interior of the liner 15 are led. On the other side, the liner 15 has a pole opening 12 via which the cavity 13 of the liner can be charged with a medium pressure. In this way, it is for example possible for a flexible tool surface 14 to be stabilized for the purposes of laying the fibres, or to be placed under the maximum design load of the laid fibrous materials.

After the fibrous material 10 has been laid in a hoop winding, the matrix material 9 is conducted via the pressure-resistant connection of the pole opening 11 to the flexible tool surface 14, wherein here, matrix material 9 is forced out of corresponding infusion openings and distributed between the flexible tool surface 14 and the fibrous material 10. If the cavity 13 is charged with a pressure, it suffices for the matrix material to be forced out of the infusion openings with a slightly elevated infusion pressure, in order that the resin is distributed between the flexible tool surface 14 of the liner 15 and the laid fibrous material 10. For this purpose, the flexible tool surface 14 may for example be textured, such that small resin channels are formed on the tool surface, through which resin channels the fibrous material can be distributed over the flexible tool surface.

1. Method for the infusion of a matrix material into a fibrous material for the production of a fiber composite component, comprising the steps:
a) providing a molding tool which has a tool surface in which there are provided infusion openings which are connected in pressure-resistant fashion to a matrix material reservoir;
b) laying the fibrous material onto the tool surface of the molding tool;
c) infusing the matrix material into the fibrous material, which has been laid onto the molding tool, by virtue of the matrix material being forced out of the infusion openings provided in the tool surface in the direction of the laid fibrous materials with an infusion pressure;
wherein the tool surface of the molding tool is of encircling form in at least one direction, wherein the tool surface includes infusion openings which are connected to the matrix material reservoir via pressure-resistant connecting elements situated at an inside, and wherein the fibrous material is laid on the tool surface in a continuously encircling form.

2. The method according to claim 1, wherein the infusion pressure with which the matrix material is forced out of the infusion openings is greater than or equal to the contact pressure with which the fibrous material lies on the tool surface.

3. The method according to claim 1, wherein the molding tool has an elastic tool surface in which the infusion openings are provided and which adjoins an internal cavity which can be charged with an internal pressure, wherein, before, during or after the laying of the fibrous material onto the elastic tool surface, the cavity is charged with an internal positive pressure and the matrix material from the matrix material reservoir is forced out of the infusion openings, provided in the elastic tool surface, with an infusion pressure which is greater than the internal positive pressure with which the cavity of the molding tool is charged.

4. The method according to claim 3, wherein, after the laying of the fibrous material, the cavity is charged with an internal positive pressure such that the contact pressure with which the fibrous material lies on the tool surface is increased.

5. The method according to claim 3 wherein after an amount of matrix material has been forced out of the infusion openings, the infusion pressure is lowered to substantially the internal pressure of the cavity, or the internal pressure of the cavity is increased to substantially the infusion pressure, in order that the matrix material that has been forced out can infuse into the fibrous material, wherein, after a time period has elapsed, the infusion pressure is increased again, or the internal pressure of the cavity is lowered again, until the infusion pressure is again greater than the internal pressure.

6. The method according to claim 1 wherein the matrix material is forced out of the infusion openings by means of a hydraulically generated infusion pressure.

7. A device for producing a fiber composite component from a fibrous material infused with matrix material, comprising:
a molding tool with a tool surface on which fibrous material can be laid, wherein, in the tool surface, there are provided one or more infusion openings which are connected in pressure-resistant fashion to a matrix material reservoir; and
a pressurization means provided for forcing the matrix material from the matrix material reservoir out of the infusion openings, in the direction of laid fibrous materials, with a predefined infusion pressure,
wherein the molding tool has a tool surface which is of encircling form in at least one direction, wherein the one or more infusion openings are in the tool surface, wherein the one or more infusion openings are connected to the matrix material reservoir via pressure-resistant connecting elements situated at an inside.

8. The device according to claim 7, further comprising a hydraulic pressurization means set up to generate a hydraulic infusion pressure for forcing the matrix material out of the infusion openings.

9. The device according to claim 7 wherein the molding tool has an elastic tool surface in which the infusion openings are provided, wherein the molding tool has an internal cavity which adjoins the elastic tool surface for being charged with an internal positive pressure in order to increase the contact pressure of laid fibrous material.
